(19) United States
(12) Patent Application Publication
(10) Pub. No.: US 2015/0056002 A1
(43) Pub. Date: Feb. 26, 2015

(54) APPARATUS FOR CONNECTING A PLURALITY OF ELONGATE MEMBERS TO FORM A SUPPORT STRUCTURE

(71) Applicant: Jeffrey Michael Olds, Seattle, WA (US)

(72) Inventor: Jeffrey Michael Olds, Seattle, WA (US)

(21) Appl. No.: 13/973,231

(22) Filed: Aug. 22, 2013

(51) Int. Cl. F16M 11/16; F16B 1/00

(52) U.S. Cl. CPC F16M 11/16; F16B 1/00
USPC 403/176

(57) ABSTRACT

An apparatus for connecting a plurality of elongate members to form a support structure for supporting an accessory is disclosed herein. In some embodiments, the apparatus comprises a rigid body having a top end and a bottom end, at least three inclined through holes and a vertical through hole within the rigid body wherein each through hole is configured for receiving a corresponding elongate member such as, for example a disassembled section of a telescopic trekking pole, and also an accessory mount configured for supporting a camera to a top end of an elongate member secured within the vertical through hole. Accordingly, a preferred embodiment is configured for interconnecting four elongate members such that three of elongate members form a tripod support base below the rigid body and the fourth elongate member extends upwardly above the rigid body and supports a camera at the top end via an accessory mount.

### FIELD OF THE DISCLOSURE

The present disclosure relates generally to the field of recreational equipment and, more particularly, an apparatus for connecting a plurality of elongate members, e.g. the various sections of a disassembled trekking pole or a plurality of ski poles, to form a support structure for supporting an accessory, e.g. a camera or telescope.

### BACKGROUND

This section provides background information related to the present disclosure which is not necessarily prior art.

There is a growing popularity of photography among recreational enthusiasts as many outdoor enthusiasts find it quite enjoyable to capture photographs during outings. Under many circumstances it is desirable but impracticical to capture pictures of oneself during a specific portion of an outing. For example, a group of hikers or climbers may wish to capture a picture which includes all members of a group and, with the inclusion of timers or remote controls on most modern cameras, this can typically be accomplished so long as there are adequate means to support and adjust the camera. However, under many circumstances attempting to support and adjust the camera within the natural environment, i.e. without the aid of a camera support, will put the camera at risk of damage. For example, if a camera owner attempts to support the camera on a log or river bed rock the camera may slip and fall to the ground. Of course the option exists to carry along a camera support such as a tripod; however, the weight of one's gear is of paramount concern to most hikers and climbers and drawback associated with the added weight of a carrying a tripod will not outweigh the benefit of being able to better support the camera.

While hikers and climbers will generally not chose to carry the additional weight of a camera tripod, they frequently chose to carry trekking poles due to the known health benefits and also for stability on rough terrain. Moreover, many modern trekking poles are telescopic and can be disassembled into numerous separate elongate members.

Despite the need for lightweight support means for cameras and other accessories during recreational outings, there are seemingly few attempts to creatively satisfy this need. Information related to one such attempt can be seen in U.S. Patent Application Publication No. 2004/0066064 A1, which published on Apr. 8, 2004, which is hereby fully incorporated herein. Therefore, there is a need for a lightweight and simple apparatus for connecting a plurality of elongate members to form a support structure.

### SUMMARY

This section provides a general summary of the disclosure, and it is not a comprehensive disclosure of its full scope or all of its features.

An apparatus for connecting a plurality of elongate members, e.g. the various sections of a disassembled trekking pole or a plurality of ski poles, to form a support structure for supporting an accessory, e.g. a camera or telescope, is disclosed herein. Simplicity of design was a key objective of the apparatus disclosed herein and, as such, in some embodiments the apparatus comprises a single piece of material. In some embodiments, the apparatus comprises a rigid body having a top end and a bottom end, three inclined through holes and a vertical through hole within the rigid body wherein each through hole is configured for receiving a corresponding elongate member such as, for example a disassembled section of a telescopic trekking pole, and also an accessory mount configured for supporting a camera to a top end of an elongate member secured within the vertical through hole. Thus, the apparatus as described in this embodiment is configured for interconnecting four elongate members such that three of elongate members form a tripod support base below the rigid body and the fourth elongate member extends upwardly above the rigid body and supports a camera at the top end via an accessory mount.

Due to the variations in diameter of the individual sections of a single telescopic trekking pole and also the variations in diameter of trekking poles in general between manufacturers, some embodiments of the apparatus disclosed herein comprise one or more sleeve elements corresponding to one or more of the inclined through holes, or the vertical through hole, or both. The insertion of a sleeve element thereby reduces the effective inner diameter of the corresponding through hole thereby optimizing the fit between through holes and their corresponding elongate members. Thus, with the inclusion of one or more sleeve elements a user may optimize their apparatus based on the specific elongate members they intend to utilize to form a support structure.

Moreover, some embodiments comprise threaded holes intersecting with one or more of the through holes which enable a screw to be tightened down against inserted elongate members, e.g. a plastic thumb screw may be used as a thumb tightened set screw to secure the various elongate members at optimal lengths so as to plumb the support structure. Accordingly, some embodiments further comprise a level indicator, e.g. a bubble level indicator, on the rigid body for reference while setting up a support structure.

The following embodiments and descriptions are for illustrative purposes only and are not intended to limit the scope of the apparatus for connecting a plurality of elongate members to form a support structure. Other aspects and advantages of the present disclosure will become apparent from the following detailed description.

### BRIEF DESCRIPTION OF THE DRAWINGS

These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

The drawings included herein are considered by the applicant to be informal.

FIG. 1 shows a perspective view of an apparatus interconnecting four elongate members, which are shown in dashed lines because they represent the environment the apparatus is intended to be used in, thereby forming a support structure in accordance with a first embodiment of the present disclosure.

FIG. 2 shows a perspective view of the apparatus for connecting a plurality of elongate members to form a support structure of FIG. 1 in accordance with the first embodiment of the present disclosure.

FIG. 3 shows a top view of the apparatus for connecting a plurality of elongate members to form a support structure of FIG. 1 in accordance with the first embodiment of the present disclosure.

FIG. 4 shows a section view A-A, taken along the line A-A of FIG. 3, of the apparatus of FIG. 1 in accordance with a first embodiment of the present disclosure.

### DETAILED DESCRIPTION

Following is a description by way of example only and with reference to the accompanying informal drawings of a manner of constructing and using the apparatus for connecting a plurality of elongate members to form a support structure. Example embodiments are provided to fully convey the scope of this disclosure to those skilled in the art. The present apparatus for connecting a plurality of elongate members to form a support structure may have additional embodiments, may be practiced without one or more of the details described for any particular described embodiment, or may have any detail described for one particular embodiment practiced with any other detail described for another embodiment. Numerous specific details are set forth as examples and are intended to provide a thorough understanding of embodiments of the present disclosure. It will be apparent to one skilled in the art that these specific details need not be employed, that example embodiments may be embodied in many different forms, and that neither should be construed to limit the scope of the disclosure. In some example embodiments, well-known processes, well-known device structures, and well-known technologies are not described in detail.

The term “generally” or other terms of degree may be utilized herein to represent the inherent degree of uncertainty that may be attributed to any quantitative comparison, value, measurement, or other representation. One skilled in the art will recognize that in manufacturing any tangible apparatus there may be predetermined tolerance specifications defining the allowable variation from nominal dimensions. For example, a standard for microplate dimensioning numbered ANSI/SLAS 1-2004 published by the American National Standards Institute discloses the acceptable variance from true parallelism certain surfaces may have. The terms are also used herein to represent the degree by which a quantitative representation may vary from a stated reference without resulting in a change in the basic function of the apparatus disclosed herein.

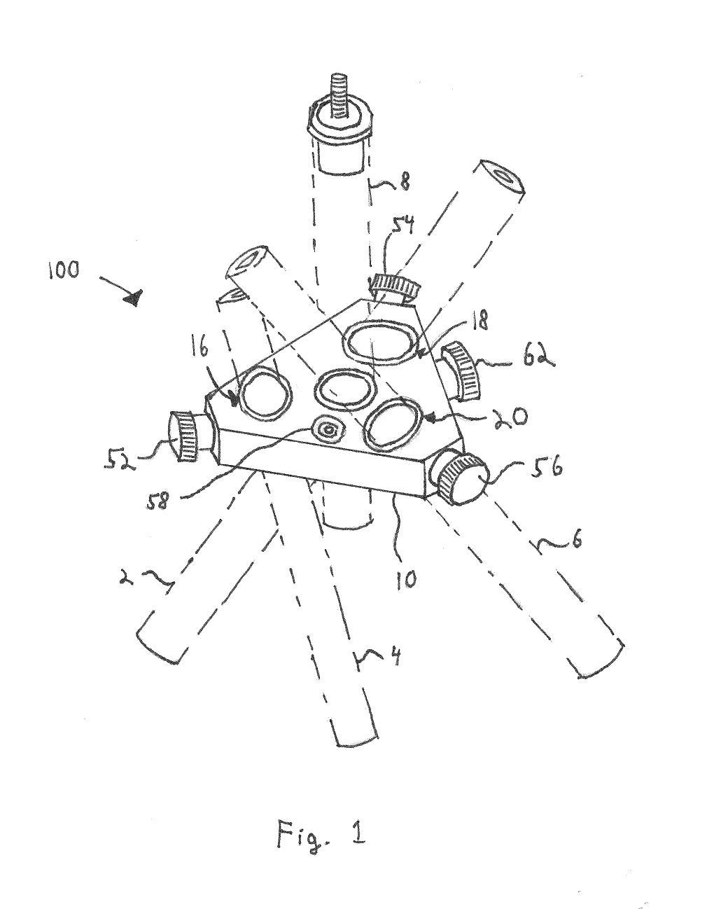

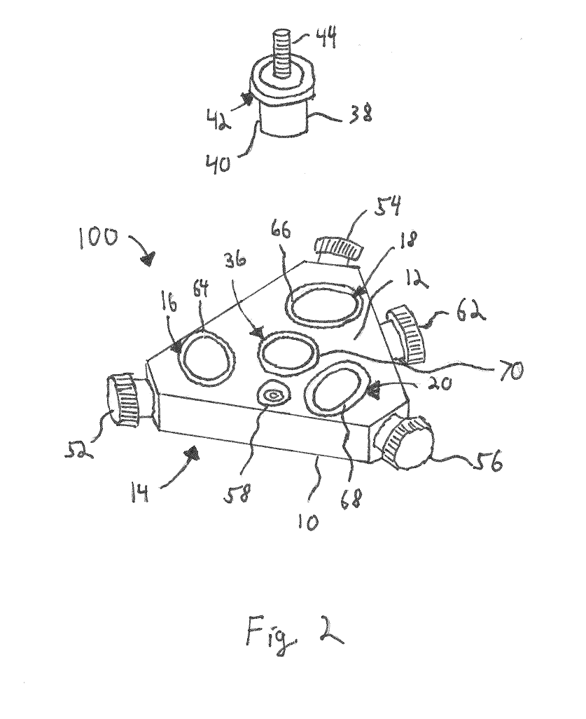

Referring now to the drawings, FIGS. 1 and 2 each show a perspective view of an apparatus 100 for connecting a plurality of elongate members to form a support in accordance with a preferred embodiment of the present disclosure. FIG. 1 illustrates the apparatus interconnecting four elongate members 2, 4, 6, 8, which are shown in dashed lines because they represent the environment the apparatus is intended to be used in, thereby forming a support structure in accordance with the preferred embodiment of the present disclosure. Preferably, the apparatus 100 is configured for interconnecting a plurality of sections of a disassembled telescopic trekking pole due to many recreational enthusiasts already choosing to carry trekking poles during recreational outings. Thus, adding the apparatus 100 to one's list of gear will have a nominal effect on the overall weight of one's gear. Although trekking poles are a preferred elongate member for the aforementioned reason(s), the apparatus may be configured to interconnect any suitable elongate members, e.g. even sticks found on a journey may be suitable for forming a support structure, and accordingly the four elongate members 2, 4, 6, 8 shown in FIG. 1 are illustrated as generic hollow cylinders rather than a specific type of elongate member.

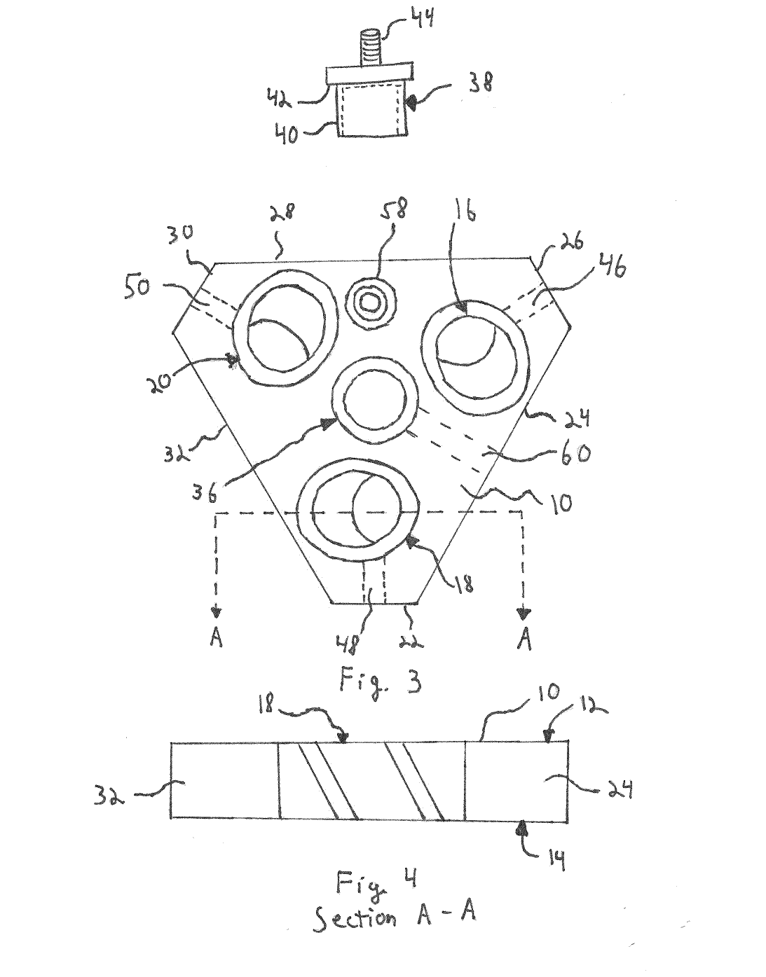

The apparatus 100 comprises a rigid body 10 having a top end 12 and a bottom end 14 and three inclined through holes 16, 18, 20 each of which are configured for receiving an elongate member. Referring specifically to FIG. 1, it will be apparent to one skilled in the art that a tri-pod style support structure is formed by interconnecting the three elongate members 2, 4, 6 due to the inclination of through holes 16, 18, 20. In one embodiment, the rigid body 10 is of uniform thickness and generally equilaterally triangular in shape as viewed from the top, see FIG. 3, and further comprises truncated corners such that the outer perimeter consists of six plane surfaces. Referring specifically to FIG. 3, the six plane surfaces are labeled 22, 24, 26, 28, 30, and 32. Moreover, in the illustrated embodiment each of these six surfaces is parallel to an opposite surface and, more specifically, surface 22 is parallel to surface 28 and surface 24 is parallel to surface 30 and, lastly, surface 26 is parallel to surface 32. In this embodiment, section line A-A of FIG. 3 is parallel to surfaces 22 and 28 and intersects with the center axis of through hole 18. Referring specifically to FIG. 4, inclined through hole 18 is shown in a section view making the inclination more easily recognizable. It has been found that an inclination of roughly 30 degrees from vertical provides sufficient inclination such that the bottom ends of the elongate members 2, 4, and 6 are spaced far enough apart to form a fairly sturdy support structure.

The apparatus 100 further comprises a means for supporting at least one accessory 34 and, in the illustrated embodiment, the means 34 comprises a generally vertical through hole 36 configured for receiving and supporting an elongate member. In a preferred embodiment, the means 34 further comprises a camera mount 38 configured for affixing a camera to an elongate member such that the camera mount may be attached to an elongate member corresponding to the generally vertical through hole so that a camera may be supported above the rigid body. In some embodiments, the camera mount 38 comprises a stepped cylindrical outer profile such that a smaller diameter lower section 40 is appropriately sized for insertion into an end of a hollow cylindrical elongate member of a predetermined inner diameter while a step 42 prevents the camera mount 38 from falling into the hollow portion of the elongate member. Such a camera mount will typically comprise a male threaded stud 44 for threading into the standard female threaded mount on the bottom end of a camera.

In a preferred embodiment, the apparatus 100 further comprises threaded holes 46, 48, 50 corresponding to and intersecting with each of the inclined through holes 16, 18, 20 and a plurality of screws 52, 54, 56. The plurality of screws are preferably made of a plastic, or other suitably soft material as compared to aluminum, so that when the screws are tightened down as a set screw to provide a clamping force against an elongate member the screw does not scratch or otherwise damage the elongate member it contacts. It has been found that plastic thumb screws are preferred in this application due to being lightweight, low cost, and easily manipulated with one's fingers even with gloves on. Moreover, having a single screw of the plurality of screws corresponding with each threaded hole such that each screw may be individually rotated to control a clamping force against individual elongate members 2, 4, and, 6 provides the benefit of being able to secure less than all of the elongate members with a desired length protruding below the rigid body 10 and then subsequently varying the length of one or more other elongate members protruding below the rigid body 10. This feature enables a user to easily level the top surface 12 of the rigid body to maximize stability of the resulting support structure thereby reducing the risk of the structure toppling over and equipment being damaged. Moreover, some embodiments comprise a level indicator 58 affixed to the top end of the rigid body. The level indicator 58 may comprise one or more of a bull's eye spirit level and a tubular spirit level. Other types of level indicators, whether now known or developed in the future, may also be utilized without departing from the spirit and scope of the apparatus 100.

In another preferred embodiment, the apparatus 100 comprises a threaded hole 60 corresponding to and intersecting with the generally vertical through hole 36 and a screw 62 corresponding with threaded hole 60. Threaded hole 60 and screw 62 serve a similar function to threaded holes 46, 48, 50 and screws 52, 54, 56 described in the preceding paragraph. Namely, as shown in FIG. 1 screw 62 may be tightened against elongate member 8 thereby providing a clamping force which prevents the elongate member 8 from sliding down through the generally vertical hole under the weight of an attached accessory.

In some embodiments, inclined through holes 16, 18, and 20 are configured for receiving corresponding elongate members of varying diameter, i.e. different members are of different diameter. For example, because many hikers carry telescopic trekking poles and because the separate sections of the separate sections are inherently different it may be undesirable under some circumstances for the inclined through holes to each have the same diameter. Moreover, because the diameters of various elongate members will vary greatly it may also be desirable for the effective inner diameters of each of the inclined through holes to be customizable in some fashion. Of course it is within the scope of the apparatus that the diameters of the inclined through holes are unequal and customizable. However, due to the cost associated with supporting multiple version of a product and the desire for a product to be functional with many types of equipment, it is preferable for the apparatus to comprise some ability for the end user to customize the apparatus 100, and more particularly the diameters of one or more of holes 16, 18, 20, and 36, based on personal preferences and requirements. Accordingly, a preferred embodiment of the apparatus 100 comprises one or more sleeves 64, 66, 68, and 70 configured for insertion into one or more of holes 16, 18, 20, and 36, in order to reduce the effective inner diameter. Of course the outer diameter of the sleeve will be sized appropriately to mate with the inner diameter of the corresponding hole and the inner diameter will be sized to mate with the corresponding elongate member for forming a support structure. In some embodiments, the apparatus 100 comprises a wide variety of sleeves which a user may use interchangeably as desired. For similar reasons to preferably choosing plastic, or other soft materials relative to aluminum, for the screw it is also preferable to utilize plastic sleeves so as not to scratch or otherwise damage the elongate members.

While preferred and alternate embodiments have been illustrated and described, as noted above, many changes can be made without departing from the spirit and scope of the apparatus for connecting a plurality of elongate members. For example, although the predominant example used throughout this application for suitable elongate members has been the various individual sections of a telescopic trekking pole, it is also within the scope apparatus 100 to be configured for utilizing ski poles, walking sticks, ice axes, and even twigs found during an outing as the required elongate members. Accordingly, the scope of the apparatus for connecting a plurality of elongate members is not limited by the disclosure of these preferred and alternate embodiments. Instead, the scope of the apparatus for connecting a plurality of elongate members should be determined entirely by reference to the claims.

What is claimed is:

1. An apparatus for connecting a plurality of elongate members to form a support structure, the apparatus comprising:
a rigid body having a top end and a bottom end and an outer profile defining a region between the top end and the bottom end, wherein the top end comprises a generally planar top surface, the bottom end comprises a generally planar bottom surface; and
the outer profile is generally triangular;
at least three inclined through holes, each inclined through hole being configured for receiving a corresponding elongate member such that a plurality of elongate members may be connected to form a support structure;
a generally vertical through hole configured for receiving and supporting a corresponding elongate member;
a threaded hole corresponding to and intersecting with the generally vertical through hole and a screw corresponding to the threaded hole for controlling a clamping force applied to an elongate member corresponding to the generally vertical through hole;
an accessory mount configured for affixing an accessory to an elongate member such that the accessory mount may be attached to an elongate member corresponding to the generally vertical through hole so that an accessory may be supported above the rigid body;
at least one sleeve corresponding to one or more inclined through hole, the generally vertical through hole, or any combination thereof;
wherein one or more sleeves of the at least one sleeve are configured for receiving corresponding elongate members of varying diameter such that a telescopic pole may be disassembled so that one or more sections of the telescopic pole may be used as an elongate member to form a support structure.

2. An apparatus for connecting a plurality of elongate members to form a support structure, the apparatus comprising:
a rigid body having a top end and a bottom end,
at least three inclined through holes, each of the at least three inclined through holes being configured for receiving a corresponding elongate member such that a plurality of elongate members may be connected to form a support structure; and
means for supporting at least one accessory whereby the at least one accessory is mechanically coupled to the rigid body.

3. The apparatus of claim 2, wherein the means for supporting at least one accessory comprises a generally vertical through hole configured for receiving and supporting a corresponding elongate member.

4. The apparatus of claim 3, wherein the means for supporting at least one accessory further comprises a camera mount configured for affixing a camera to an elongate member such that the camera mount may be attached to an elongate member corresponding to the generally vertical through hole so that a camera may be supported above the rigid body.

5. The apparatus of claim 2, wherein the top surface of the rigid body is generally planar and the bottom surface of the rigid body is generally planar.

6. The apparatus of claim 2, further comprising:
at least one threaded hole corresponding to each inclined through hole wherein each threaded hole intersects with the corresponding inclined through hole; and
a plurality of screws, wherein a single screw of the plurality of screws corresponds with each threaded hole such that each screw may be individually rotated to control a clamping force applied to a corresponding elongate member.

7. The apparatus of claim 3, further comprising:
at least one threaded hole corresponding to the generally vertical through hole wherein the at least one threaded hole intersects with the generally vertical through hole; and
at least one screw corresponding with the at least one threaded hole the at least one screw may be rotated to control a clamping force applied to an elongate member corresponding to the generally vertical through hole.

8. The apparatus of claim 2, wherein the at least three inclined through holes are configured for receiving corresponding elongate members of varying diameter such that a telescopic pole may be disassembled so that one or more sections of the telescopic pole may be used as an elongate member to form a support structure.

9. The apparatus of claim 2, further comprising:
at least one sleeve corresponding to one or more of the at least three inclined through holes, each sleeve comprising an inner diameter configured to receive an elongate member of a predetermined diameter and an outer profile configured for insertion into one or more of the at least three inclined through holes.

10. The apparatus of claim 9, wherein one or more sleeves of the at least one sleeve are configured for receiving corresponding elongate members of varying diameter such that a telescopic pole may be disassembled so that one or more sections of the telescopic pole may be used as an elongate member to form a support structure.

11. The apparatus of claim 2, further comprising a level indicator affixed to the top end of the rigid body.

12. The apparatus of claim 2, wherein the rigid body is aluminum.
